(19) United States
(12) Patent Application Publication
(10) Pub. No.: US 2022/0180259 A1
(43) Pub. Date: Jun. 9, 2022

(54) System and Method for Dynamic Project Forecasting and Real-Time Visualization

(71) Applicant: Proodos, Inc., Winston-Salem, NC (US)

(72) Inventors: Suyash Shekhar Pendalwar, Winston-Salem, NC (US); Akhil Shekhar Pendalwar, Lawrenceville, GA (US); Marjorie Tyler Pendalwar, Winston-Salem, NC (US)

(21) Appl. No.: 17/116,411

(22) Filed: Dec. 9, 2020

(51) Int. Cl. G06Q 10/06; G06N 3/08

(52) U.S. Cl. CPC G06Q 10/0635; G06N 3/08; G06Q 10/063114; G06Q 10/06375

(57) ABSTRACT

The present invention is a system and method for dynamic project forecasting and real-time visualization using a Three-Dimensional (3D) project map, where the map provides end users the ability to proactively visualize predicted project bottlenecks and project risks at the task level. In an embodiment, the instant innovation utilizes machine learning to provides intelligent suggestions, custom resource forecasts, and skills matching that make it easy to substitute resources and modify task details when bottlenecks are identified. The instant innovation improves upon existing project management solutions by including data elements derived from initial iterations into subsequent iterations of system input. In an embodiment, the instant innovation employs an interactive 3D project map to deliver computed insights to a user.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Although Project Management is a well understood discipline, modern Project Management continues to improve the methods used. Project Management as a practice requires data-driven decision making that is summarily followed by inter-personal communication of, and adherence to, decisions so derived. In turn, data-driven decision making largely involves at least two components: Data Computation and Data Analysis, where Computation involves subjecting project indicia to one or more data-deriving functions, and where Analysis involves deriving actionable insights from the results of such activity. A variety of traditional tools exist for the analysis of static data sets. Existing tools provide Project Management insights as text and/or graphical output.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is an overview of the dynamic forecast process consistent with certain embodiments of the present invention.

FIG. 2 is a view of a sub-process for displaying toggled Special Views consistent with certain embodiments of the present invention.

FIG. 3 is a view of a user experience of a Project Map Graphical Interface consistent with certain embodiments of the present invention.

FIG. 4 is a view of a user experience of a 3D Project Map Risk View consistent with certain embodiments of the present invention.

FIG. 5 is a process view of the dynamic forecast system consistent with certain embodiments of the present invention.

FIG. 6 is a process view of the forecast computation consistent with certain embodiments of the present invention.

FIG. 7 is a view of a representation of forecast time output data consistent with certain embodiments of the present invention.

FIG. 8A is a process view of the availability forecast output data consistent with certain embodiments of the present invention.

FIG. 8B is a view of a representation of availability forecast output data consistent with certain embodiments of the present invention.

FIG. 9 is a view of a user experience of a default 3D Project Map consistent with certain embodiments of the present invention.

FIG. 10 is a view of a user experience of a 3D Project Map Financial View consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language).

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “device” refers to any electronic communication device with network access such as, but not limited to, a cell phone, smart phone, tablet, iPad, networked computer, internet computer, laptop, watch or any other device, including Internet of Things devices, a user may use to interact with one or more networks.

However, unless specifically stated otherwise as apparent from the following discussion, it is appreciated that throughout the description, discussions utilizing terms such as “processing” or “computing” or “calculating” or “determining” or “displaying” or “analyzing” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMS), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The processes and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

Although Project Management has been the subject of a variety of gradual improvements, no existing system permits for the proactive determination of process bottlenecks and risks while also displaying the effects of such bottlenecks and risks in a user-friendly graphical format. Thus, there is a need for a system and method for dynamic project forecasting and real-time visualization using a Three-Dimensional (3D) project map. In an embodiment, such system and method provide end users the ability to proactively visualize predicted project bottlenecks and project risks at the task level. In a non-limiting example, end users include individuals, Project Managers, and key project stakeholders, while bottlenecks and project risks include those related to project budget, schedule, and scope.

In an embodiment, the instant innovation provides intelligent suggestions, custom resource forecasts, and skills matching that make it easy to substitute resources and modify task details when bottlenecks are identified. This technology makes it easy to stay on time and within budget given project constraints. In an embodiment, the instant innovation improves upon existing project management solutions by including data elements derived from initial iterations into subsequent iterations of system input.

In an embodiment, the instant innovation employs a 3D project map to reflect forecast calculations which depend on project and/or task level information and activity tracking input provided by end users. The instant innovation displays at least the following output on the 3D Map:

a) A default Standard View that displays all the project tasks in a timeline. In an embodiment, clicking on a task permits a user to see all task level details (such as, by way of non-limiting example, worker assigned, due dates, and comments). In an embodiment, task Dependencies may be shown as yellow arched lines connecting the current and any predecessor tasks.

b) A Risk View which may be toggled by a user. In an embodiment, when the risk view is toggled, color grading (such as, by way of non-limiting example, blue, yellow, orange, and red) and increased elevation are applied to tasks based on the number of risk factors computed for each task. In an embodiment, “elevation” refers to an importance factor that heightens or lessens a task along the axis which is representative of the factor-affecting criterion. Risk factors in an embodiment may include:
i) Communication Gap: one or more differences between managerial perception of task priority and difficulty and worker perception of task priority and difficulty;
ii) Availability: high or low resource availability score average (which may be a factor of predicted asset utilization and/or capacity) predicted for the time window near the task due date;
iii) Task Overdue: a timing situation in which the current date is after an assigned project due date; and/or
iv) Custom Risk Factors: additional or substitute project-specific factors, the designation of which allows a manager to create a metric unique to the project being managed. Custom Risk Factors are also included in the risk view.

c) A Financial View that may be toggled by a user. When in an embodiment the financial view is toggled, color grading (by way of non-limiting example, blue, yellow, orange, and red) and increased elevation are applied to tasks based on the percentage of a fiscal budget spent on each task. Budget calculations are based on actual hours input by the worker responsible for task completion and include fixed costs specified in advance.

d) A nested Skills Match and Resource Availability Forecast dialog box is selectable by a user when a task is selected on the 3D map. The skills match suggests workers with comparable work history and/or relevant work experience to effectively complete the selected task. The availability forecast view shows each available resource and an overview of capacity over a specified time period. By way of non-limiting example, the specified time period may be 30, 60, or 90 days. By including these two features in its calculations, it is possible for the instant innovation to assist the user in making efficient resource allocation decisions. A key component of the instant innovation is that it is continuously updating its input data in real-time. The moment workers record time they spend working on assigned tasks and modify task-level details such as project status (for instance, by way of non-limiting example, marking projects as “complete” or “incomplete”), project end date, priority, and difficulty, the instant innovation recomputes forecast calculation updates and risk factors, intelligent suggestions, resource availability forecasts, and skills matches. This newly computed data is then immediately pulled into the 3D project map as a real-time update.

In an embodiment, the instant innovation's combination of an underlying forecast system and unique use of the 3D space mapping and color grading permits the instant innovation to present to a user not only present issues that a particular project is facing, but also predicted project risks. The instant innovation's ability to show project tasks that are current and/or projected bottlenecks permits a user to stay ahead of project pitfalls. In an embodiment, the instant innovation permits a user to define custom risk factors to make project forecasting more adaptable and customizable to the unique workflow within an organization.

In an embodiment, the instant innovation makes unique use of 3D space mapping and color grading to show tasks that are financial risks. This approach represents a novel way to determine which tasks currently pose a risk of exceeding the budget allocated to them. In an embodiment, the custom adaptive resource forecast of the present innovation takes into account feedback from the worker on each worker's human perception of daily workload. In an embodiment, the present innovation may seek and record feedback from each user regarding metrics which describe how certain workload aspects engendered feelings within the worker. By way of non-limiting example, the instant innovation may seek worker input as to whether the project volume was too great, causing stress, or whether the project subject left the worker feeling unsatisfied. The end goal of such data collection is to enhance the overall quality of worker project contributions and the efficiency with which projects are completed. Over time, this feedback permits the instant innovation to adapt to worker preferences and helps a manager to make more strategic resource allocation decisions. The instant innovation's utilization of project skills match, which shows if a worker has worked on a similar task in the past and provides a percentage match based on the number of required skills covered by the worker, similarly ensures economy and efficiency in project execution.

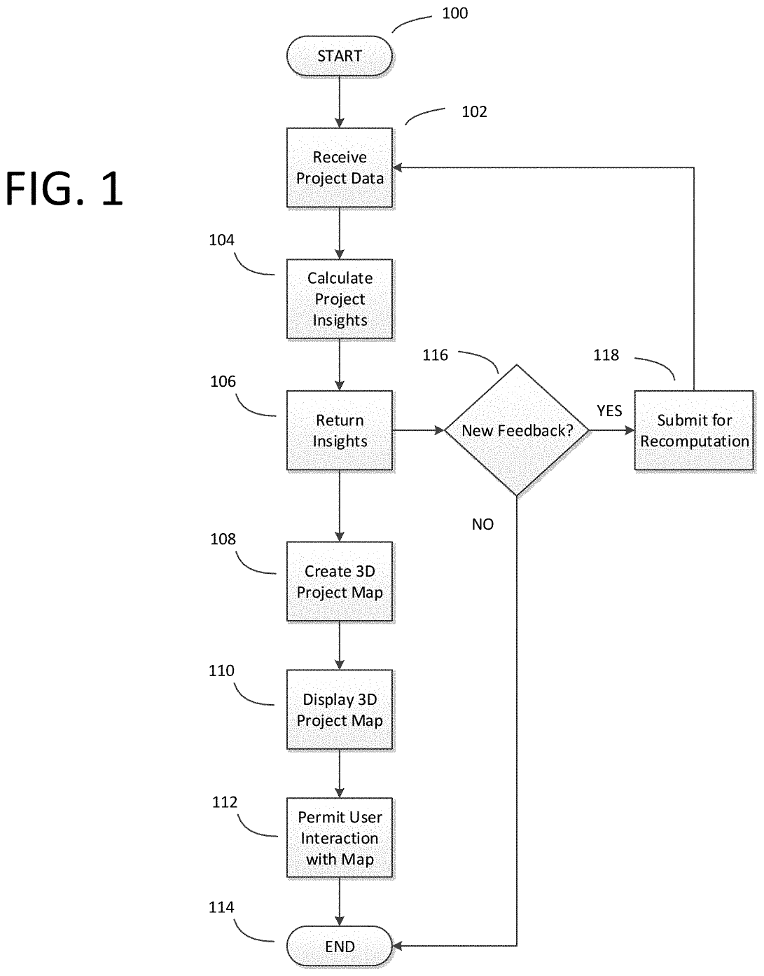

Turning now to FIG. 1, an overview of the dynamic forecast process consistent with certain embodiments of the present invention is shown. At 100 the process starts. At 102, the instant innovation receives one or more project data sets reflecting project indicia related to, by way of non-limiting example, project completion, scope, and efficiency. At 104 the instant innovation uses the received data sets to calculate project insights. Calculated insights include forecast calculations and risk factors, including but not limited to future project bottlenecks. Calculated insights also include intelligent suggestions, resource availability forecasts, and human asset skills-to-tasks matching. Such calculations may be performed using one or more Deep Neural Networks and/or Machine Learning algorithms or methodologies. At 106 the instant innovation returns one or more calculated insights based at least in part on the analysis of project risks provided as an output of the Deep Neural Network and/or Machine Learning processes related to budget, schedule, and scope. At 108 the instant innovation creates a human-visually-perceptible 3D Project Map. The 3D Project Map may in an embodiment display all of the project tasks for a particular project along a timeline. A user may be capable of viewing all task level details and Dependencies. In an embodiment, project Dependencies may be shown as yellow arched lines connecting current and predecessor tasks. At 110 the instant innovation displays the 3D Project Map to a user and at 112 the instant innovation permits the user to interact with the 3D Project Map by, for instance, selecting a visual representation by toggling on one or more Special Views. Toggling is provided as a non-limiting example only. If at 116 one or more worker feedback data sets is provided to the system, such worker feedback may be composed of work product and/or human perception factors. At 118 the process may submit the computed insights and the worker feedback data sets for re-computation and updating derived insights by returning to the project data receipt step at 102. If at 116 no new feedback is detected, or once the user has interacted with the map at 112, the process ends at 114.

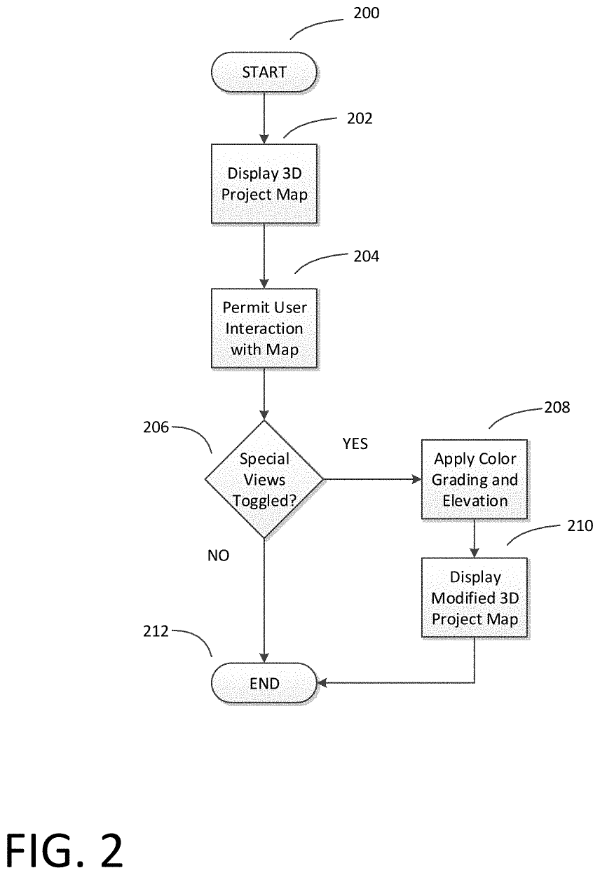

Turning now to FIG. 2, a view of a sub-process for displaying toggled Special Views consistent with certain embodiments of the present invention is shown. The sub-process starts at 200. At 202 the instant innovation displays a human-visually-perceptible 3D Project Map on an electronic display device. In an embodiment such 3D Project Map may display all project tasks in a timeline. At 204 the instant innovation permits a human user to interact with the 3D Project Map. One way in which the instant innovation permits user interaction is through the selection of Special Views, where Special Views may be pre-configured or pre-established as data views that are of particular interest to a user of the system. Special Views may exist for any identified category of data input to the system. The Special View data category may be displayed along any axis of the 3D project map as a label on that selected axis. If at 206 the user has toggled a button triggering the display of one or more Special Views, the instant innovation applies color grading and elevation to the 3D Project Map data at 208 and at 210 displays the modified 3D Project Map to the user. At 212 the sub-process ends. If at 206 the user does not toggle to select one or more Special Views, then the sub-process ends at 212.

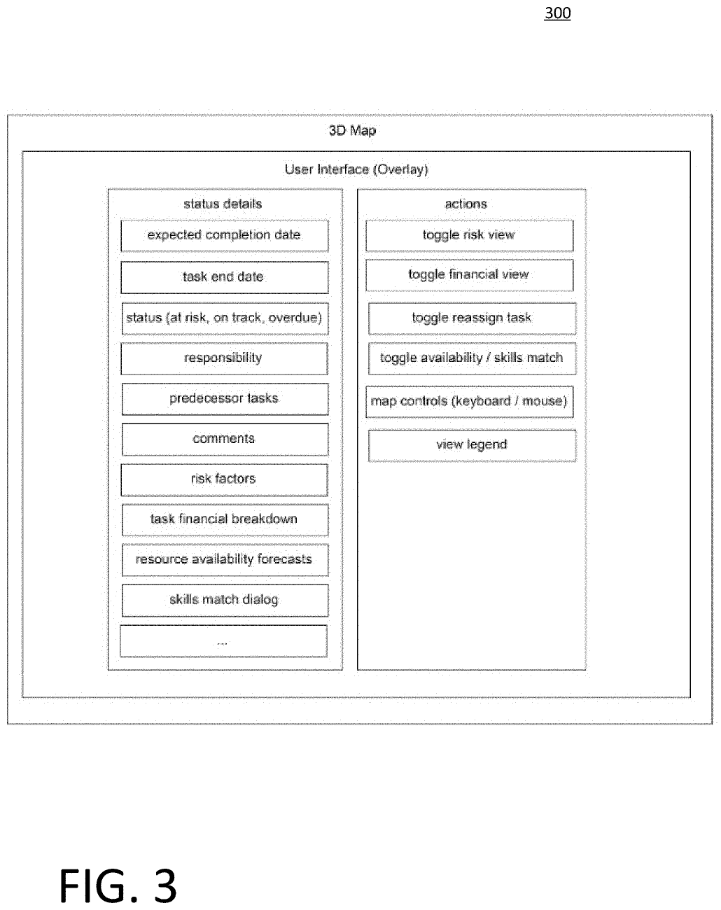

Turning now to FIG. 3, a view of a user experience of a Project Map Graphical Interface consistent with certain embodiments of the present invention is shown. At 300 is an embodiment of the user interface with which a user may interact to view Project Status and Actions.

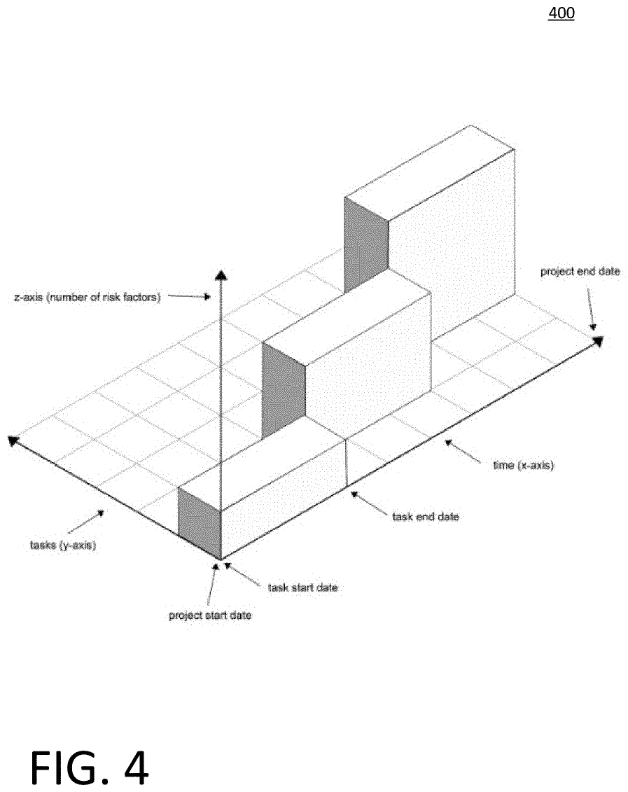

Turning now to FIG. 4, a view of a user experience of a 3D Project Map Risk View consistent with certain embodiments of the present invention is shown. At 400 is an embodiment of the 3D Project Map of the instant innovation showing a variety of project indicia along three axes, each axis representing quantification one of the following: time, tasks, and risk.

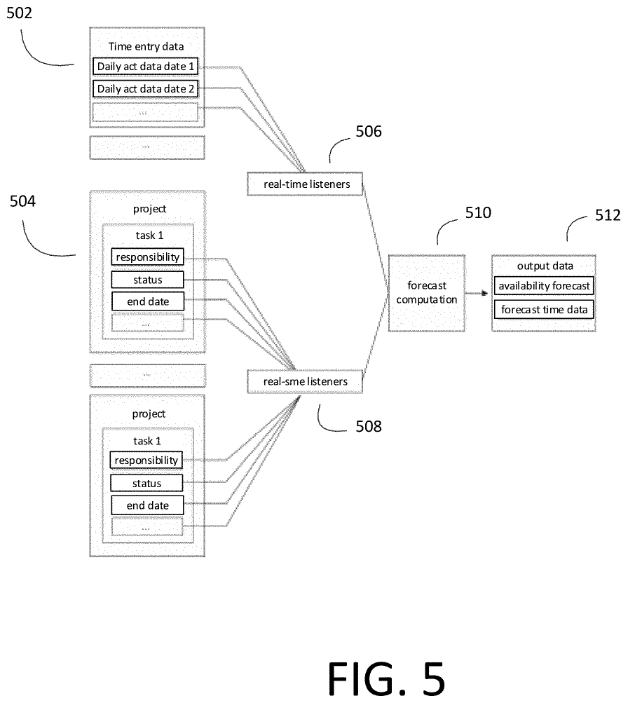

Turning now to FIG. 5, a process view of the dynamic forecast system consistent with certain embodiments of the present invention is shown. At 502 the system collects Time Entry Data for a series of Daily Acts associated with a project and at 506 the system employs one or more first real-time procedures and/or functions to respond to the data collection event of 502. Similarly, at 504 the system collects Project Data for a series of Projects, where each Project is defined at least in part by indicia including its responsible party, its status, and its end date. At 508 the system employs one or more second real-time procedures and/or functions to respond to the data collection event of 504. At 510 the system utilizes machine learning to perform forecast computations regarding the managed project. At 512 the system returns data to a user, such data including but not necessarily limited to an availability forecast and a forecast of project-related time data.

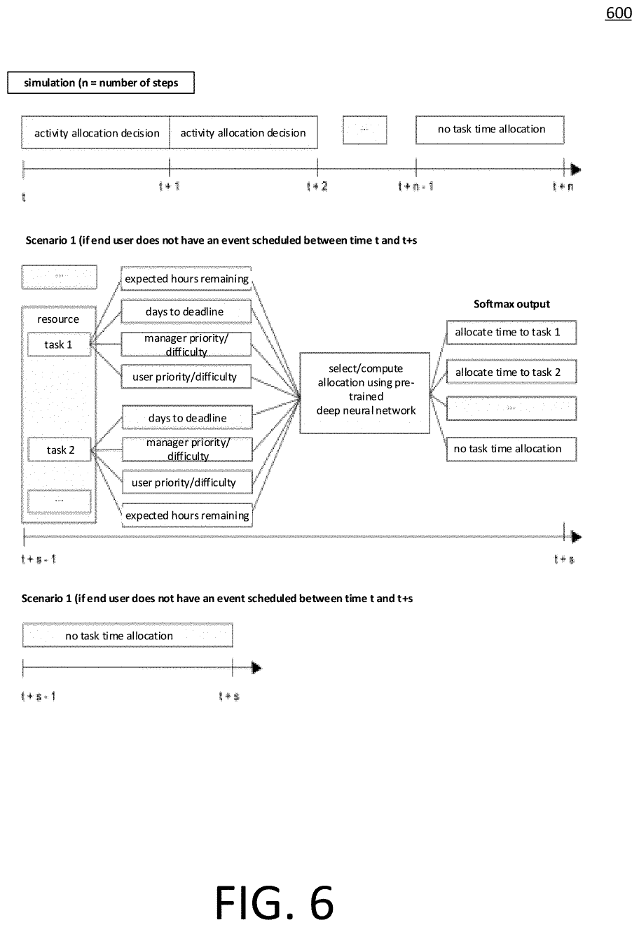

Turning now to FIG. 6, a process view of the forecast computation consistent with certain embodiments of the present invention is shown. At 600 is a graphical representation of the system's use of machine learning to recalculate project threat prediction and project efficiency based at least upon worker feedback, calculated project threats and calculated project efficiency insights.

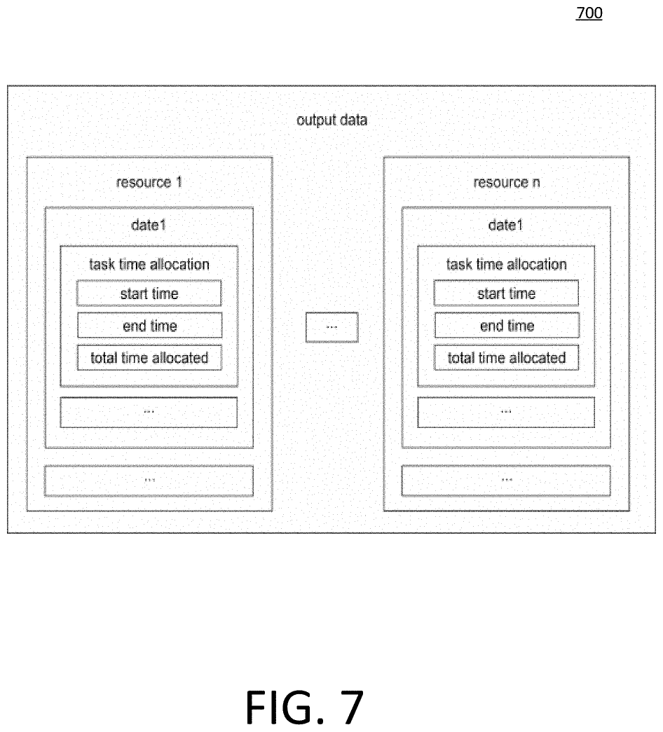

Turning now to FIG. 7, a view of a representation of forecast time output data consistent with certain embodiments of the present invention is shown. At 700 is a graphical representation of the system's output of recalculated project threat prediction and project efficiency indicators. Such indicators may be represented as nested boxes, where each box is a function of the nested boxes within it.

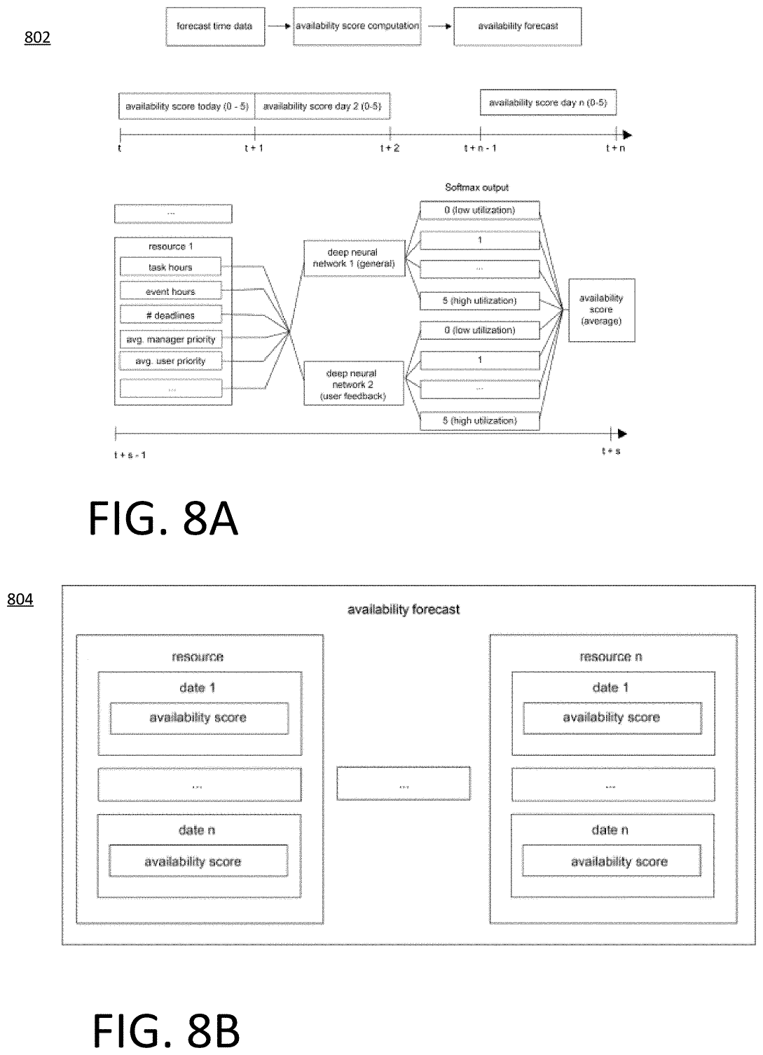

Turning now to FIG. 8A, a process view of the availability forecast output data consistent with certain embodiments of the present invention is shown. At 802 is a graphical representation of the system's use of machine learning and/or one or more deep neural networks to recalculate project threat prediction and project efficiency, with a focus on asset availability.

Turning now to FIG. 8B, a view of a representation of availability forecast output data consistent with certain embodiments of the present invention is shown. At 804 is a graphical representation of the system's output of recalculated project threat prediction and project efficiency indicators, with a focus on asset availability. Such indicators may be represented as nested boxes, where each box is a function of the nested boxes within it.

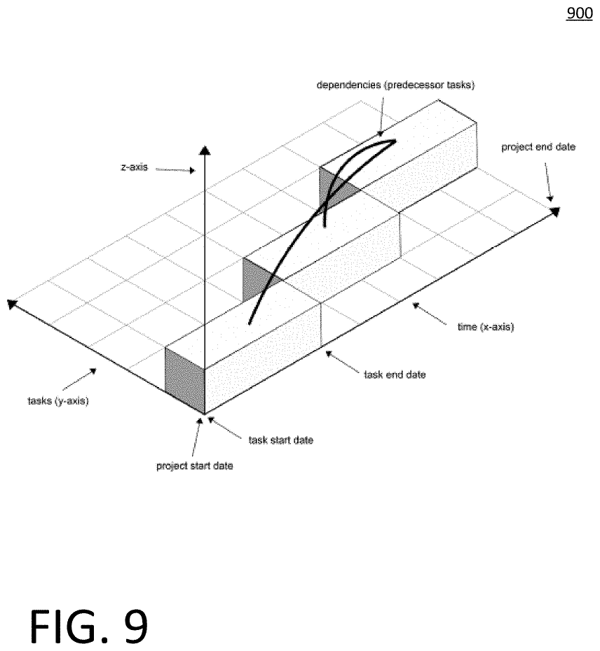

Turning now to FIG. 9, a view of a user experience of a default 3D Project Map consistent with certain embodiments of the present invention. At 900 is an embodiment of the default 3D Project Map of the instant innovation showing a variety of project indicia, including Dependencies, along three axes, each axis representing quantification one of the following: time, tasks, and risk is shown.

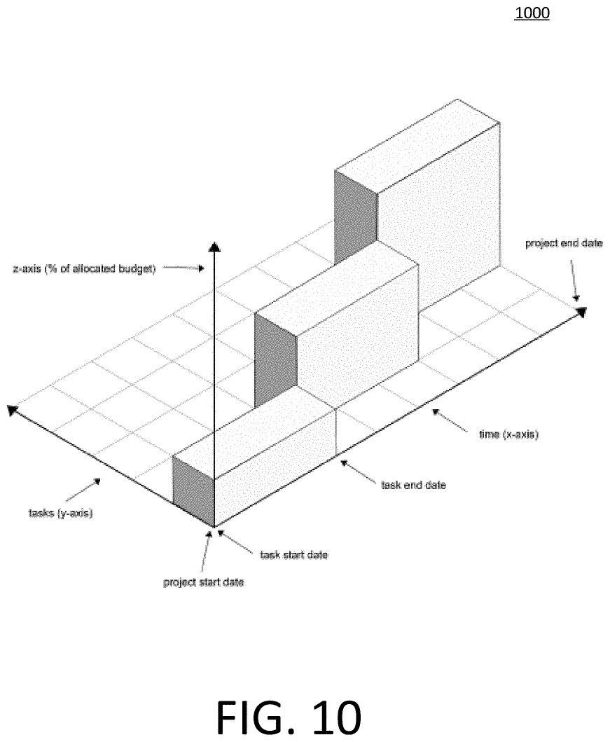

Turning now to FIG. 10, a view of a user experience of a 3D Project Map Financial View consistent with certain embodiments of the present invention. At 1000 is an embodiment of the 3D Project Map Financial View of the instant innovation showing a variety of project indicia along three axes, each axis representing quantification one of the following: time, tasks, and allocated budget is shown.

While certain illustrative embodiments have been described, it is evident that many alternatives, modifications, permutations and variations will become apparent to those skilled in the art in light of the foregoing description.

I claim:

1. A method for Dynamic Project Forecasting and Real-Time Visualization, comprising:
collecting one or more first data sets, the one or more first data sets representing managed human project data;
using machine learning to predict one or more calculated project threats based upon the one or more first data sets;
using machine learning to determine calculated project efficiency insights;
collecting one or more second data sets, the one or more second data sets each representing worker feedback, calculated project threats and calculated project efficiency insights;
using machine learning to recalculate project threat prediction and project efficiency insights in real-time based upon the one or more second data sets and
providing a three-dimensional graphical representation of the calculated and/or recalculated output to a user.

2. The method of claim 1, where the managed human project data includes task level data.

3. The method of claim 1, where the calculated project threats include project risks related to budget, schedule, and scope.

4. The method of claim 1, where the calculated project efficiency insights include intelligent suggestions, custom resource forecasts, and worker-task skills matching.

5. The method of claim 1, where the machine learning is a product of analysis by one or more Deep Learning Neural Networks.

6. The method of claim 1, where the three-dimensional graphical representation displays project tasks in a timeline.

7. The method of claim 1, where the three-dimensional graphical representation includes color grading.

8. The method of claim 1, where the three-dimensional graphical representation reflects application of one or more importance factors, where any one importance factor affects project attribute priority along the axis that attribute represents.

9. A system for Dynamic Project Forecasting and Real-Time Visualization, comprising:
a server having a data processor;
the server collecting one or more first data sets, the one or more first data sets representing managed human project data;
using machine learning to predict one or more calculated project threats based upon the one or more first data sets;
using machine learning to determine calculated project efficiency insights;
collecting one or more second data sets, the one or more second data sets each representing worker feedback, calculated project threats and calculated project efficiency insights;
using machine learning to recalculate project threat prediction and project efficiency insights in real-time based upon the one or more second data sets and
providing a three-dimensional graphical representation of the calculated and/or recalculated output to a user.

10. The system of claim 9, where the managed human project data includes task level data.

11. The system of claim 9, where the calculated project threats include project risks related to budget, schedule, and scope.

12. The system of claim 9, where the calculated project efficiency insights include intelligent suggestions, custom resource forecasts, and worker-task skills matching.

13. The system of claim 9, where the machine learning is a product of analysis by one or more Deep Learning Neural Networks.

14. The system of claim 9, where the three-dimensional graphical representation displays project tasks in a timeline.

15. The system of claim 9, where the three-dimensional graphical representation includes color grading.

16. The system of claim 9, where the three-dimensional graphical representation reflects application of one or more importance factors, where any one importance factor affects project attribute priority along the axis that attribute represents.
